(19) United States
(12) Patent Application Publication
(10) Pub. No.: US 2001/0034221 A1
(43) Pub. Date: Oct. 25, 2001

(54) Method of combining at least two received signals of a telecommunication system

(76) Inventors: Thomas Schutz, Leonberg (DE); Matthias Schreiner, Renningen (DE)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/824,716

(22) Filed: Apr. 4, 2001

(30) Foreign Application Priority Data
Apr. 25, 2000 (EP) 00 440 115.4

(51) Int. Cl. H04B 1/06

(52) U.S. Cl. 455/273; 455/137

(57) ABSTRACT

A method of combining at least two received signals (A, A′) of a telecommunication system is described. A first combining algorithm (B1) is processed for providing a resulting signal (S1). A second combining algorithm (B2) is processed for providing a second resulting signal (S2). One of the two resulting signals (S1 or S2) is selected, wherein the selection is depending on the two resulting signals (S1, S2).

The invention relates to a method of combining at least two received signals of a telecommunication system wherein a first combining algorithm is available for providing a resulting signal. The invention also relates to a receiver of a telecommunication system for combining at least two received signals wherein a first combining algorithm is available for providing a resulting signal.

In known telecommunication systems, the two received signals are provided to the combining algorithm which creates two weighting factors. The two received signals are multiplied with these weighting factors and are then added up into the resulting signal.

A number of different combining algorithms are available. Some of them are well adapted to overcome e.g. a local interferer and others are good for overcoming e.g. noise. The problem of the known technique, therefore, is the question which combining algorithm should be used.

It is an object of the invention to offer a method and a receiver for combining at least two received signals in a telecommunication system which are well adapted to any possible situation, i.e. noise or a local interferer.

This object is solved by the invention in that a second combining algorithm is available for providing a second resulting signal, and that one of the two algorithms is selected to be processed, so that one of the two resulting signals is provided, wherein the selection is depending on the two received signals.

This solution has the advantage that it needs only little effort as only one of the algorithms is actually processed. Due to the dependency of the selection from the two received signals, the selected algorithm is well adapted to the actual situation.

The object is also solved by the invention in that a second combining algorithm is processed for providing a second resulting signal, and that one of the two resulting signals is selected, wherein the selection is depending on the two resulting signals.

This solution has the advantage that the two resulting signals themselves are used to decide which one of these two resulting signals is better adapted to the actual situation. The decision is therefore more reliable. However, both algorithms have to be processed which requires more calculation efforts.

The object is also solved by the invention in that a second combining algorithm is processed for providing a second resulting signal, and that the two resulting signals are combined, wherein the combination is depending on the two resulting signals.

This solution has the advantage that in a situation in which any of the two algorithms provides an advantage, the advantages of both algorithms may be used due to the combination instead of a selection. However, this additional combination requires additional calculation efforts.

In all three solutions, the advantages of several algorithms are available due to a flexible switching or combining strategy. Compared to the prior art, the invention therefore always provides a better adaption to any actual situation due to the possiblity of always providing the best algorithm for the respective actual situation.

In particular, it is advantageous if one of the two algorithms is a temporal reference algorithm and the other one of the two algorithms is a spatial reference algorithm. These algorithms are supplemental to each other so that it is possible to always select one of them for any possible actual situation.

Further embodiments as well as further advantages of the invention are outlined in the following description of the enclosed figures.

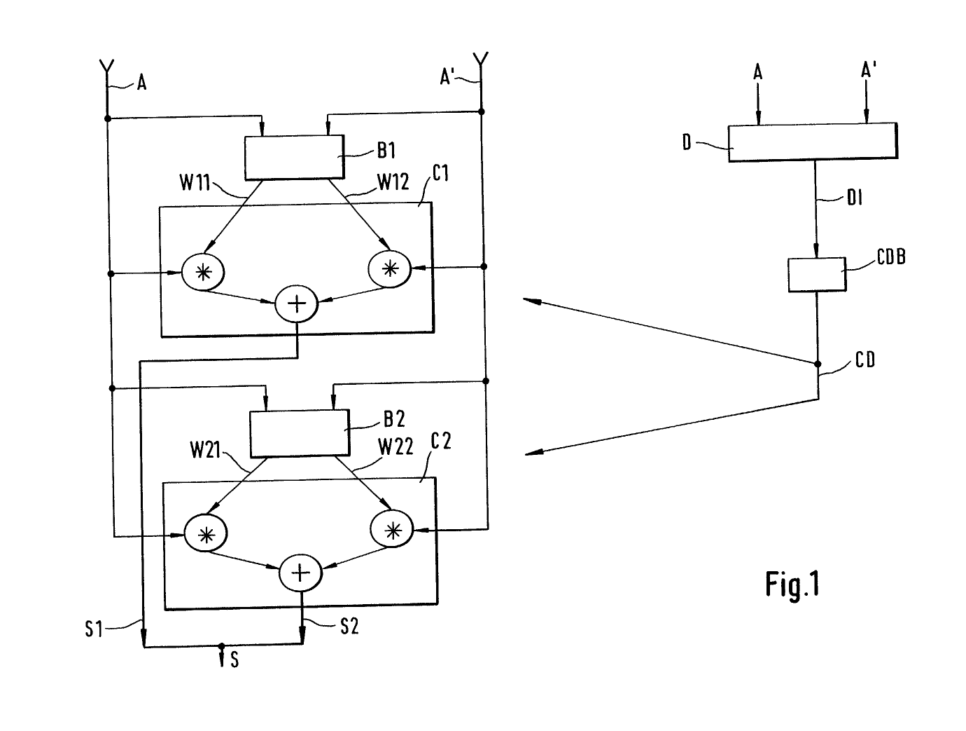

FIG. 1 shows a schematic block diagram of a first embodiment of a method of combining two received signals of a telecommunication system according to the invention,

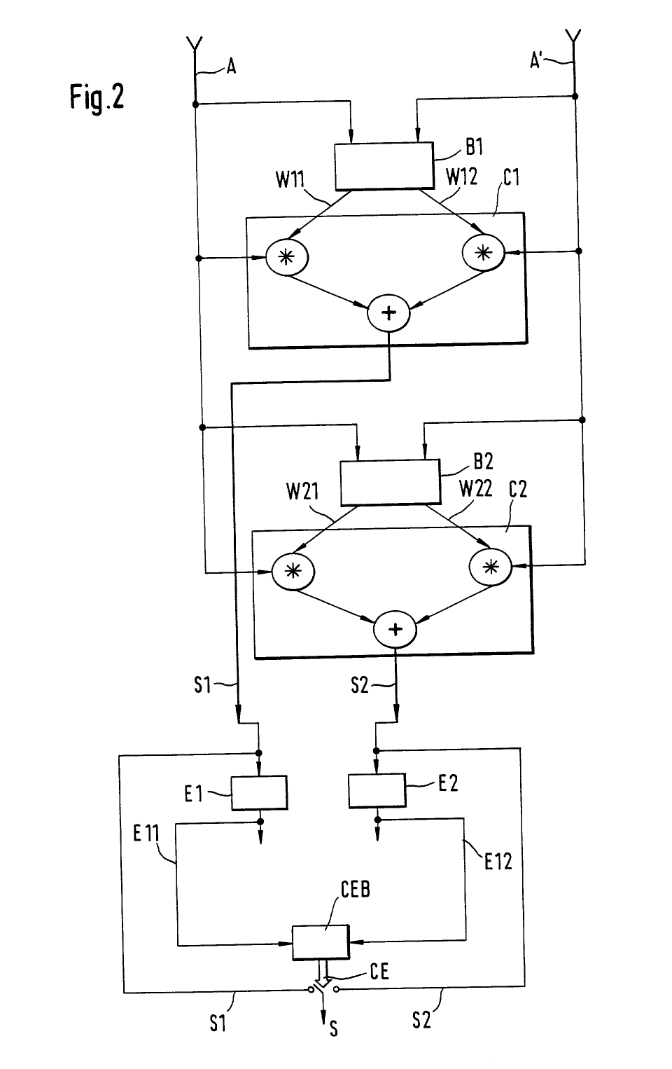

FIG. 2 shows a schematic block diagram of a second embodiment of a corresponding method according to the invention, and

FIG. 2 shows a schematic block diagram of a third embodiment of a corresponding method according to the invention.

In a telecommunication system, e.g in a GSM telecommunication system, a base transeiver station (BTS) is able to communicate with a number of mobile stations (MS). The BTS is equipped with two antennas for sending and receiving signals to and from the MS. The two antennas are located with a distance from each other which has a value of at least some wavelengths of the transmitted signals.

Due to the two antennas, the BTS is able to receive two signals from one and the same MS. This enables the BTS to provide a so-called diversity mode in the uplink direction. In this diversity mode, the two received signals are combined into an improved signal which is then further processed.

The combination of the two received signals is performed with specific combining algorithms. This combination and any further processing of the received signals is done by digital processors.

In so-called temporal reference algorithms, a known part of the transmitted signal is used to optimize the combination of the two received signals such that the difference between the combined signal and the known part becomes a minimum. The known part may be a training sequence, a spreading code or the like.

The so-called direct matrix invertion algorithm or the so-called least squares algorithm are examples of such temporal reference algorithms. These algorithms are advantageous for overcoming a directional disturber, e.g. an interferer.

So-called spatial reference algorithms are blind estimation techniques, i.e. there is no known part or the like which is used by the algorithm. Instead, these algorithms are based on the power of the received signals and on a resulting, so-called eigenvalue analysis of a covariance matrix.

The so-called optimum ratio algorithm is an example of such a spatial reference algorithm. These algorithms are advantageous for overcoming a non-directional disturber, e.g. noise.

FIG. 1 shows a first embodiment of combining two received signals A, A′ which are received by two antennas of a receiver of a BTS.

In the right hand part of FIG. 1, the two received signals A, A′ are provided to an estimator D which produces a value or a set of values DI describing the actual condition, e.g. noise or an interferer. A subsequent compare and decision block CDB provides a decision information CD depending on this information. This decision information CD includes the information which one of two possible algorithms shall be processed for combining the received signals A, A′.

These two possible algorithms for combining the received signals A, A′ are shown in the left hand part of FIG. 1. The two arrows of the decision information CD are pointing in the direction of the two algorithms. The decision information CD is selecting only one algorithm out of these two possible algorithms.

The two algorithms B1, B2 are both provided with the two received signals A, A′ as an input. The first algorithm B1 creates weighting factors w11, w12 which are provided to a corresponding weighting block C1. In the weighting block C1, the two received signals A, A′ are multiplied with the weighting factors w11, w12 and are then added up into a first resulting signal S1. The second algorithm B2 creates corresponding weighting factors w21, w22. Then, in a weighting block C2, a second resulting signal S2 is created.

Due to the selection of only one of these two possible algorithms, only the selected algorithm is processed. The other non-selected algorithm is not processed. Therefore, only the resulting signal S1 of the first algorithm B1 or the resulting signal S2 of the second algorithm B2 is available. This resulting signal S1 or S2 is then used for further processings as an improved signal S.

Summarized, in the method of FIG. 1, one of two algorithms B1, B2 is selected to be processed, wherein the selection is depending on the received signals A, A′.

FIG. 2 shows a second embodiment of combining two received signals A, A′ which are received by two antennas of a receiver of a BTS. Features of FIG. 2 which are identical with FIG. 1, carry the same reference sign.

As already described in connection with FIG. 1, the two received signals A, A′ are provided to the two algorithms B1, B2 which provide the resulting signals S1, S2. However, in contrast to FIG. 1, there is no decision to process only one of the two algorithms in FIG. 2.

Instead, both algorithms B1, B2 are processed so that both resulting signals S1, S2 are available. The two resulting signals S1, S2 are provided to respective quality estimators E1, E2 which produce a quality information EI1, EI2 for each of the two resulting signals S1, S2. A subsequent compare and decision block CEB compares the estimated qualities and provides a decision information CE based on this comparison. This decision information CE includes the information which one of the two resulting signals S1, S2 shall be used for further processing.

This decision information CE is then used to select that resulting signal S1 or S2 which shall be used as an improved signal S for further processing. As an example, this selection may be performed by a switch which depends on the decision information CE.

Summarized, in the method of FIG. 2, both algorithms B1, B2 are processed and one of the two resulting signals S1, S2 is then selected, wherein the selection is depending on the resulting signals S1, S2 themselves.

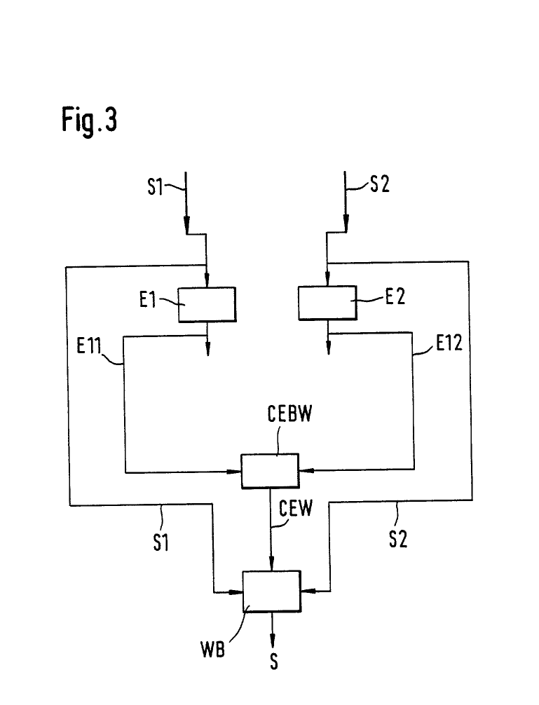

FIG. 3 shows a third embodiment of combining two received signals A, A′ which is based on the embodiment of FIG. 2. Features of FIG. 3 which are identical with FIG. 2, carry the same reference sign.

As already described in connection with FIG. 2, the two received signals A, A′ are provided to the two algorithms B1, B2 which provide the resulting signals S1, S2. However, in contrast to FIG. 2, there is no selection of one of the two resulting signals S1, S2.

Instead, the two resulting signals S1, S2 are combined. For that purpose a weight information CEW is provided to a weighting block WB. This weight information CEW is provided by a weight generation block CEBW depending on the quality information EI1, EI2.

The weighting block WB performs a combination of the two resulting signals S1, S2 wherein these signals are weighted with the weight information CEW. The result of the weighting block WB is an improved signal S which is then used for further processing.

Summarized, in the method of FIG. 3, both algorithms B1, B2 are processed and the two resulting signals S1, S2 are then combined, wherein the combination is performed depending on the resulting signals S1, S2 themselves.

In all three embodiments of FIGS. 1 to 3, the two algorithms B1, B2 are supplemental to each other. In particular, the first algorithm B1 may be a temporal reference algorithm and the second algorithm B2 may be a spatial reference algorithm. This has the advantage that the first algorithm B1 is able to overcome a directional disturber, and that the second algorithm B2 is able to overcome a non-directional disturber.

In the method of FIG. 1, that algorithm B1 or B2 of the two algorithms B1, B2 is selected which is better suited for the actual situation. E.g., if there is a local interferer actually present, this is detected by the estimator D. Then, the compare and decision block CDB selects the first algorithm B1 to be processed in order to overcome this local interferer.

In the method of FIG. 2, that resulting signal S1 or S2 of the two resulting signals S1, S2 is selected which is better suited for the actual situation. E.g., if the performence is noise-limited, the decision block CEB is able to detect which one of the two algorithms B1, B2 is able to overcome this noise by comparing the quality information EI1, EI2. Then, the compare and decision block CEB selects the resulting signal S2 of the second algorithm B2.

In the method of FIG. 3, the two resulting signals S1 and S2 are combined such that always that one of the two algorithms B1, B2 has a higher weight which is better adapted to the present situation. E.g., if a local interferer is present, the resulting signal S1 of the first algorithm B1 will get a higher weight than the resulting signal S2 of the second algorithm B2.

It has to be mentioned that not only two antennas may be used but also more than two antennas. The received signals of these antennas are then provided to the respective algorithms.

Furthermore, it has to be mentioned that it is also possible to use other kind of algorithms for combining the received signals. As well, it is possible to use more than two algorithms for combining the received signals.

1. A method of combining at least two received signals (A, A′) of a telecommunication system wherein a first combining algorithm (B1) is processed for providing a resulting signal (S1), characterized in that a second combining algorithm (B2) is processed for providing a second resulting signal (S2), and that the two resulting signals (S1 and S2) are combined, wherein the combination is depending on the two resulting signals (S1, S2).

2. The method of claim 1, characterized in that the quality of the two resulting signals (S1, S2) is estimated.

3. The method of claim 2, characterized in that the estimated quality of the two resulting signals (S1, S2) is used to weight the combination of the two resulting signals (S1 and S2).

4. The method of one of claims 1 to 3, wherein one of the two algorithms (B1) is a temporal reference algorithm and the other one of the two algorithms (B2) is a spatial reference algorithm.

5. The method of one of claims 1 to 4, wherein more than two algorithms (B1, B2) are used.

6. A receiver of a telecommunication system for combining at least two received signals (A, A′) wherein a first combining algorithm (B1) is processed for providing a resulting signal (S1), characterized in that a second combining algorithm (B2) is processed for providing a second resulting signal (S2), and that means are provided for combining the two resulting signals (S1 and S2), wherein the combination depends on the two resulting signals (S1, S2).
